(19) United States
(12) Patent Application Publication
(10) Pub. No.: US 2006/0007964 A1
(43) Pub. Date: Jan. 12, 2006

(54) Laser beam generating device

(76) Inventor: Yu-Sung Lin, Taipei (TW)

Correspondence Address: Raymond Sun, 12420 Woodhall Way, Tustin, CA, 92782, US

(21) Appl. No.: 10/973,143

(22) Filed: Oct. 26, 2004

(30) Foreign Application Priority Data
Jul. 6, 2004 (TW) 93120213

(51) Int. Cl. H01S 3/10

(52) U.S. Cl. 372/9

(57) ABSTRACT

A laser beam generating device has an underframe and a laser main body. The underframe has a guide mechanism. The laser main body generates a laser beam or plane, and has a turning mechanism that rotates inside the guide channel, and travels along the guide mechanism, in a manner such that the laser beam or laser plane can be radiated in horizontal and vertical directions.

### BACKGROUND OF THE INVENTION

1. Field of the Invention

The present invention relates to a laser beam generating device, and in particular, to a laser beam generating device having a turning function so as to generate a laser plane that is capable of switching between horizontal and vertical directions.

2. Description of the Related Art

It is a common practice in architecture and decoration to use a laser beam generating device for projecting laser beam dots, straight lines, cross lines or a variety of other laser beams on to objects as secondary means for demarcating reference lines or planes. These laser beam generating devices may include a plurality of vials or other horizontal sensors for the detection of the level or verticality of the laser beam.

The conventional laser beam generating device (such as a uniaxial rotary laser leveler) is typically used to generate a laser beam that is perpendicular to the horizontal plane, and a laser plane that is parallel to the horizontal plane. When a laser plane that is perpendicular to the horizontal plane is required for reference, the entire rotary laser leveler would have to be turned, leaving one side of the laser leveler as a reference bottom plane for the generation of the laser plane. Unfortunately, this turning action may affect the previously-adjusted level, thereby making new adjustments necessary and rendering the operation to be inconvenient.

For other conventional uniaxial rotary laser levelers, it may not be necessary to turn the entire laser leveler to generate a laser plane that is perpendicular to the horizontal plane for reference. Instead, a laser main body is provided on an elongated underframe via a rotary shaft, and the laser main body is rotated about the rotary shaft along the underframe, using one side of the laser main body as the reference bottom for generating the laser plane. However, the elongated frame increases the overall space of the system.

Thus, there remains a need for a uniaxial rotary laser leveler that overcomes the drawbacks mentioned above.

### SUMMARY OF THE INVENTION

It is an object of the present invention to provide a laser beam generating device, which, after turning the laser main body, maintains the previously-adjusted level, thereby providing convenient use to the user.

It is another object of the present invention to provide a laser beam generating device which has a compact overall size.

In order to accomplish the objects of the present invention, the present invention provides a laser beam generating device having an underframe and a laser main body. The underframe has a guide mechanism. The laser main body generates a laser beam or plane, and has a turning mechanism that rotates inside the guide channel, and travels along the guide mechanism, in a manner such that the laser beam or laser plane can be radiated in horizontal and vertical directions.

### BRIEF DESCRIPTION OF THE DRAWINGS

FIG. 1A is a perspective view of a laser beam generating device in accordance with one embodiment of the present invention shown emitting a horizontal plane.

FIG. 1B is a perspective view of the underframe of the laser beam generating device of FIG. 1A.

FIG. 1C is a perspective view of the laser main body of the laser beam generating device of FIG. 1A.

FIG. 2 is an exploded perspective view of the underframe of FIG. 1B.

FIG. 3 is a bottom perspective view of the underframe of FIG. 1B.

FIG. 4 is a perspective view of the laser main body of the laser beam generating device of FIG. 1C without the cap.

FIG. 5A is an exploded perspective view of the movement of the laser beam generating device of FIG. 1A.

FIG. 5B is a perspective view of the movement of FIG. 5A.

FIG. 6 is a bottom perspective view of the upper part of the underframe of FIG. 1B.

FIG. 7 is a perspective view of the laser beam generating device of FIG. 1A shown emitting a vertical plane.

### DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

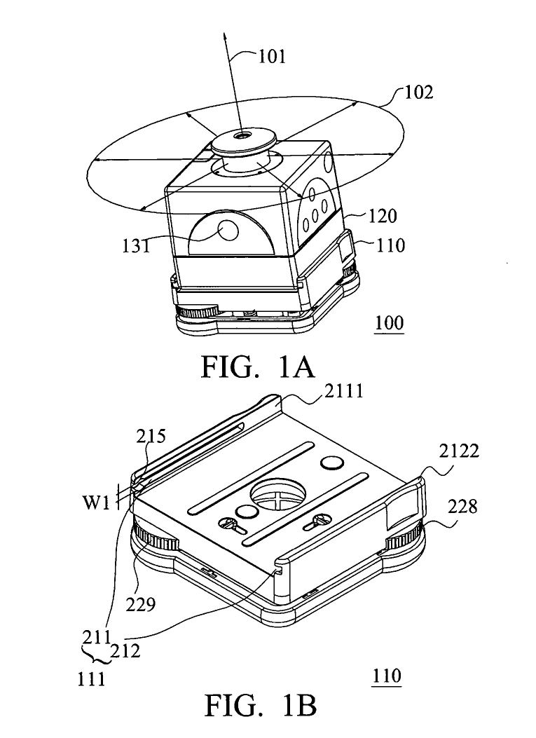

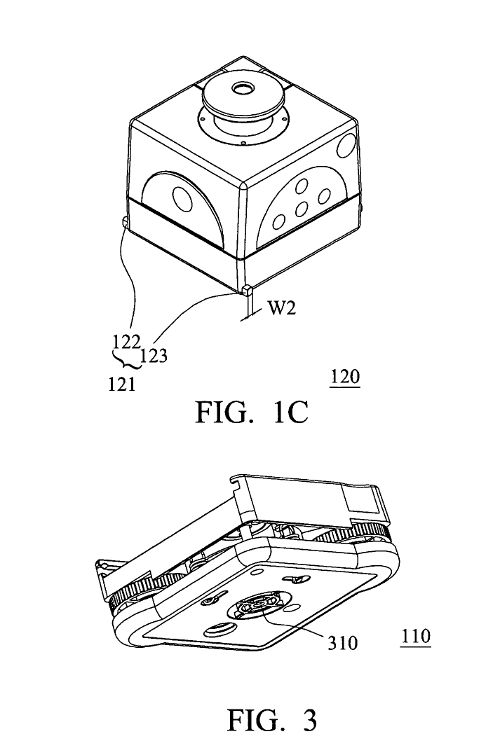

FIGS. 1A-6 illustrate a laser beam generating device in accordance with one embodiment of the present invention. The laser beam generating device is a uniaxial rotary laser leveler 100 that generates a laser beam 101 that is perpendicular to the horizontal plane, and a laser plane 102 that is parallel to the horizontal plane, as shown in FIG. 1A. The laser leveler 100 also includes a turning function where it is capable of turning the laser plane 102 into a laser plane 102 that is perpendicular to the horizontal plane (see FIG. 7) in a manner such that only minor or no adjustments are needed to maintain the accuracy of the laser plane 102 after the turning operation.

The rotary laser leveler 100 includes an underframe 110 and a laser main body 120. The underframe 110 has a guide mechanism 111 (see FIG. 1B) and the laser main body 120 has a turning mechanism 121 (see FIG. 1C) that allows the laser main body 120 to be turned and slid along the guide mechanism 111. The guide mechanism 111 on the underframe 110 has guide channels 211 and 212 provided in opposing vertical walls 2111 and 2122, respectively, that are disposed on opposite sides of the underframe 110. The turning mechanism 121 of the laser main body 120 has protrusion pins 122 and 123 provided on opposite sides of the laser main body 120, with each pin 122 and 123 adapted to be retained within a respective guide channel 211 and 212.

Each guide channel 211 and 212 is provided in the form of a longitudinal groove. On one end of each guide channel 211 and 212 is provided a generally round rotation recess 215 having a diameter that is larger than the width W1 of the corresponding guide channel 211 and 212. Each protrusion pin 122 and 123 is generally cylindrical with both sides cut off to form a truncated cylinder, and corresponds to one round rotation recess 215. In addition, the width W2 of each pin 122, 123 is slightly smaller than the width W1. Therefore, the protrusion pins 122 and 123 can be inserted into the guide channels 211 and 212 of the underframe 110, and the laser main body 120 can then be turned downward by 90 degrees about the pivot axis defined by the pins 122, 123 in their corresponding recesses 215 to reach the position shown in FIG. 1A. The laser main body 120 can subsequently be turned upwardly by 90 degrees about the same pivot axis, and then the pins 122, 123 can be slid backwards along the guide channels 211, 212 to the ends of the respective guide channels 211, 212 to reach the position shown in FIG. 7.

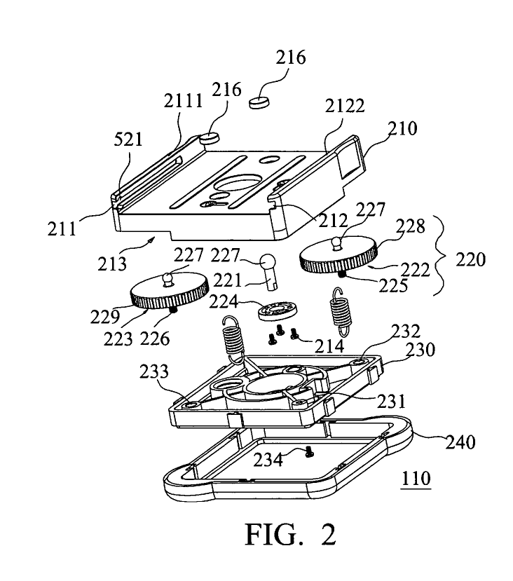

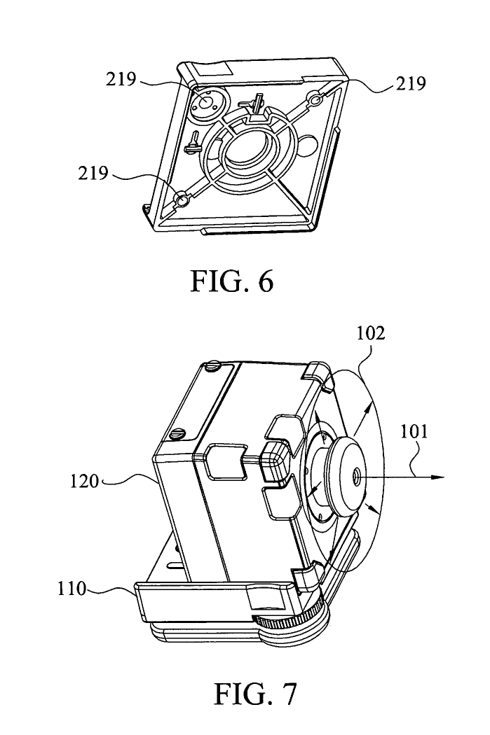

Referring now to FIG. 2, the underframe 110 includes an upper part 210, a lower part 230, an adjustable supporting kit 220, and a rubber pad 240. Each side of the upper part 210 includes one of the vertical walls 2111 or 2122 with its guide channel 211 or 212, and the bottom 213 of the upper part 210 has three universal joint bearing sockets 219 (see FIG. 6) that are positioned to form an isosceles right angled triangle. The lower part 230 also has three holes 231, 232 and 233, each corresponding to one of the three universal joint bearing sockets 219 on the bottom 213 of the upper part 210. The holes 232 and 233 are blind holes, and the hole 231 is a through hole. The rubber pad 240 is provided to prevent the laser leveler 100 from experiencing damage.

The adjustable supporting kit 220 includes a first supporting post 221 that is adapted to be secured in the hole 231 at the rectangular position of the isosceles right angled triangle, and the second and third supporting posts 222 and 223 that are screwed into the holes 232 and 233, respectively, that are positioned at the opposing diagonal corners of the isosceles right angled triangle. A universal joint 227 is provided at the top of each of the first supporting post 221, the second supporting post 222 and the third supporting post 223, with each universal joint 227 adapted to be received inside one of the universal joint bearing sockets 219. The first supporting post 221 is joined to the upper part 210 by three bolts 214 that extend through a securing seat 224. A bolt 234 is screwed into the inner threads of the first supporting post 221 through the hole 231 to secure the first supporting post 221 to the the lower part 230. The second supporting post 222 and the third supporting post 223 have outer threads 225 and 226, respectively, that are screwed into the inner threads of the holes 232 and 233, respectively. Adjusting discs 228 and 229 are secured to the second and third supporting posts 222 and 223, respectively, and are used to adjust the tilt of the second and third supporting posts 222 and 223, respectively. Therefore, adjustments can be made by rotating the adjusting discs 228 and/or 229 to tilt the upper part 210 of the underframe 110 (with the universal joint 227 of the first supporting post 221 acting as a pivot), so as to adjust the level of the laser main body 120.

To removably secure the laser main body 120 on the underframe 110, two magnets 216 are embedded in the upper part 210 to attract a metal piece (not shown) provided in a corresponding position on the bottom of the laser main body 120 when the laser main body 120 is in the position of FIG. 1A. The magnets 216 also attract a metal piece 131 (see FIG. 1A) that is provided in a corresponding position on one side of the laser main body 120 when the laser main body 120 is turned to the position shown in FIG. 7.

Referring now to FIG. 3, a crossing center mark 310 is provided at the center of the bottom of the lower part 230 of the underframe 110 to function as a reference point that corresponds to the laser beam 101.

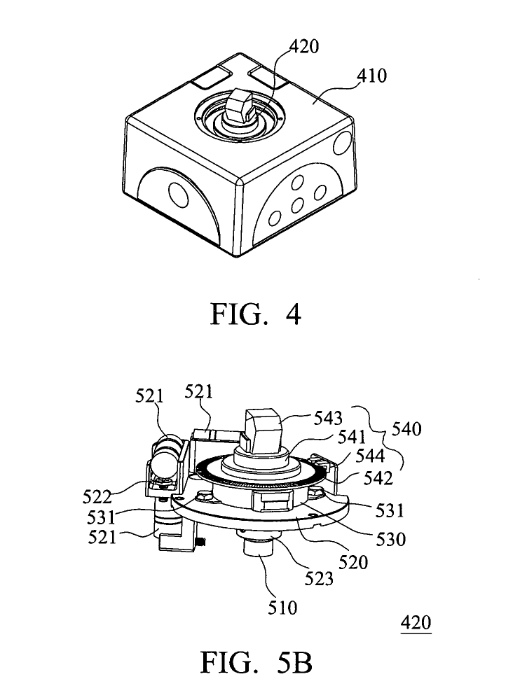

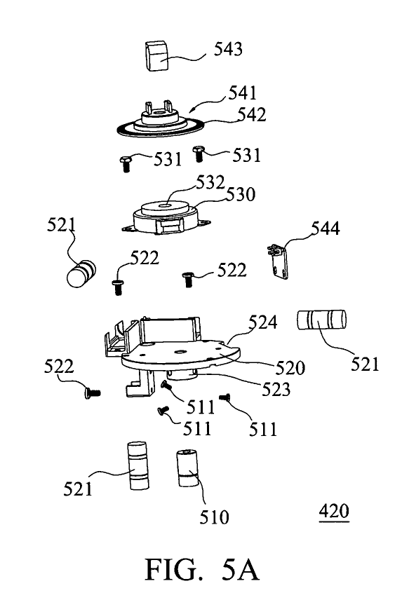

Referring now to FIG. 4, the laser main body 120 has a shell 410 and a movement 420 that generates the required laser beam. The movement 420 is described in connection with FIGS. 5A and 5B, and includes a movement seat 520, a laser module 510, a hollowed motor 530 and a prism kit 540. The movement seat 520 has three vials 521 that are positioned perpendicular to each other for the detection of the level or the accuracy of the parallel laser plane 102. The angles between the laser beams/laser planes projected by the laser module 510 and the vials 521 are adjusted by turning three respective bolts 522.

The laser module 510 functions as a laser source, and is axially secured in a sleeve 523 at the bottom of the movement seat 520 by three bolts 511 that extend in radial directions. The hollowed motor 530 is secured on top of the movement seat 520 using bolts 531. The prism kit 540 is glued onto, and driven by, the hollowed motor 530 for splitting the laser beam source generated by the laser module 510 to generate the laser beam 101 and laser plane 102. The hollowed motor 530 is provided with a through hole 532 in its center, so that the hollowed motor 530 can be positioned between the laser module 510 and the prism kit 540 without interrupting the projection of the laser beam from the laser module 510 (which can be projected through the through hole 532).

The prism kit 540 includes a prism seat 541 having a dial 542, a prism 543 glued on top of the prism seat 541, and a speed sensor 544 that is secured on the side 524 of the movement seat 520. The speed sensor 544 can detect the revolutions per minute (rpm) of the hollowed motor 530 by using a graduated scale on the dial 542.

In use, the laser main body 120 can be secured to the underframe 110 in the position of FIG. 1A by sliding the pins 122, 123 into the respective guide channels 211, 212. The laser main body 120 can be pivoted with respect to the underframe 110 about a pivot axis defined by the pins 122, 123 and the recesses 215. The horizontal level of the laser main body 120 can be adjusted by adjusting the discs 228 and/or 229 of the underframe 110, which tilt the two opposing diagonal corners of the upper part 210 about the pivot defined by the first supporting post 221. In this position of FIG. 1A, a horizontal laser plane 102 is generated. If the user wishes to change the laser plane 102 to a vertical laser plane, the user can rotate the laser main body 120 by ninety degrees to the position shown in FIG. 7. Because the previously-adjusted level of the upper part 210 is not altered during the rotation of the laser main body 120, only minor, or no, adjustments are needed to maintain the accuracy of the laser plane 102 after the turning operation.

While the description above refers to particular embodiments of the present invention, it will be understood that many modifications may be made without departing from the spirit thereof.

What is claimed is:

1. A laser beam generating device, comprising:
an underframe having a guide mechanism; and
a laser main body that generates a laser beam or plane, the laser main body having a turning mechanism that rotates and travels along the guide mechanism in a manner such that the laser beam or laser plane can be radiated in horizontal and vertical directions.

2. The device of claim 1, wherein the underframe has two opposing sides, and the guide mechanism comprises two vertical walls, with each vertical wall disposed on one of the sides of the underframe, and wherein each vertical wall has a guide channel.

3. The device of claim 2, wherein each guide channel includes a generally round rotation recess having a diameter that is larger than the width of the guide channel.

4. The device of claim 2, wherein the turning mechanism comprises two protrusion pins, with each pin positioned inside one of the two guide channels of the underframe.

5. The device of claim 4, wherein each protrusion pin is shaped like a truncated cylinder.

6. The device of claim 1, wherein the underframe comprises:
a. an upper part having:
two opposing sides,
a vertical wall disposed on each of the two opposing sides of the underframe, with each vertical wall having a guide channel,
three universal joint bearing sockets at the bottom of the upper part and positioned to form an isosceles right angled triangle;
b. a lower part having three holes corresponding to the universal joint bearing sockets; and
c. an adjustable supporting kit including:
a first supporting post secured in the hole at the rectangular position of the isosceles right angled triangle,
second and third supporting posts secured in the other two holes, each of the second and third supporting posts having an adjusting disc, and
wherein each of the first, second and third supporting posts has a universal joint.

7. The device of claim 6, further comprising a rubber pad secured on the lower part.

8. The device of claim 1, wherein the laser main body comprises a movement for generating a laser beam and a laser plane which is perpendicular to the laser beam.

9. The device of claim 8, wherein the movement comprises:
a movement seat having three vials which are perpendicular to each other;
a laser module emitting a laser beam source, the laser module axially secured in a sleeve at the bottom of the movement seat;
a hollowed motor secured on top of the movement seat; and
a prism kit secured on top of, and driven by, the hollowed motor for splitting the laser beam source to generate the laser beam and the laser plane.

10. The device of claim 9, wherein the prism kit comprises:
a prism seat including a dial;
a prism secured on the prism seat; and
a speed sensor secured on one side of the movement seat for sensing the rotation speed of the hollowed motor.

11. The device of claim 1, wherein the underframe has a center mark.

12. The device of claim 11, wherein the center mark is in the form of a cross.

13. The device of claim 1, wherein the underframe has at least one embedded magnet, and wherein the laser main body has a first metal piece provided on the bottom of the laser main body, and a second metal piece provided on one side of the laser main body.

14. The device of claim 1, further including an adjusting mechanism coupled to the underframe that adjusts the level of the laser main body with respect to the underframe.

15. A laser beam generating device, comprising:
an underframe having two opposing vertical walls, with each vertical wall having a guide channel, and with each guide channel having a rotation recess;
a laser main body that generates a laser beam or plane, the laser main body having a protrusion pin fitted for rotation within a corresponding recess to rotate the orientation of the laser main body with respect to the underframe, and the pin received in the guide channel for sliding movement therein.

16. The device of claim 15, wherein the recess has a diameter that is larger than the width of the guide channel.

17. The device of claim 15, further including an adjusting mechanism coupled to the underframe that adjusts the level of the laser main body with respect to the underframe.
